(19) United States
(12) Patent Application Publication
(10) Pub. No.: US 2005/0285855 A1
(43) Pub. Date: Dec. 29, 2005

(54) Method of rapidly building multiple three-dimensional pipes

(75) Inventors: Ching-Chang Chien, Taipei (TW); Cheng-Yung Liu, Taipei (TW); Chia-Hsiang Hsu, Taipei (TW)

Correspondence Address: BACON & THOMAS, PLLC, 625 SLATERS LANE, FOURTH FLOOR, ALEXANDRIA, VA, 22314, US

(73) Assignee: CoreTech System Co., Ltd., Taipei (TW)

(21) Appl. No.: 10/919,330

(22) Filed: Aug. 17, 2004

(30) Foreign Application Priority Data
Jun. 23, 2004 (TW) 093118015

(51) Int. Cl. G06T 15/00

(52) U.S. Cl. 345/419; 703/1; 700/98

(57) ABSTRACT

A method of rapidly building multiple three-dimensional pipes includes three primary steps: step of accepting inputs of geometric parameters; step of deriving the surface shape of multiple joined pipes according to geometric parameters; and step of deriving meshing points which present three-dimensional meshes of multiple joined pipes. There are “vacant areas” and “overlap areas” situation occurred joined area of pipes. The present invention divides joined area into “direct overlap areas”, “90 degree area” and “filling area” based on the intersecting angle of pipes.

### BACKGROUND OF THE INVENTION

1. Field of the Invention

The present invention relates to a method of rapidly building multiple three-dimensional pipes for CAD, CAE, CAM or computer graphic designs.

2. Description of the Related Art

In the design of an injection mold, the runner design affects the quality of the injected product, especially when dealing with larger sizes or geometrically complicated designs.

The number and arrangement of the runners are ideally subjected to computer simulation to obtain the best design.

There are two prior art computer simulating methods:

In the first prior art method, a user must build up a three-dimensional model in CAD software, utilizing a mesh generator to generate a triangular surface mesh of the surface in the three-dimensional model. Three-dimensional meshes are then generated from the surface mesh towards the inside of the model. However, this method requires the user to spend time building the model; during this period it is not easy to control the quality of the meshes and the number of element layers. Furthermore, the suitable resolution of the meshes can be obtained by an experienced user.

In second prior art method, a mapping method is utilized for generating three-dimensional meshes; the user needs to know the geometric shape and geometric subdivisions, and utilizes the mapping method to generate three-dimensional meshes on an area by area basis. This method is capable of generating high quality meshes, and is capable of controlling the number of element layers; however, it requires very long process times, as well as a lot experience and knowledge on the part of the user.

Both prior art methods require very long processing times, and a professional, experienced user.

Therefore, it is desirable to provide a method of rapidly building multiple three-dimensional pipes to mitigate and/or obviate the aforementioned problems.

### SUMMARY OF THE INVENTION

A main objective of the present invention is to simplify the design of multiple three-dimensional pipes for mold runner designs.

In order to achieve the objective of the present invention, a method of rapidly building multiple three-dimensional pipes comprises:

Step A: accepting inputs of geometric parameters of the multiple three-dimensional pipes, each pipe utilizing an axial line to indicate a length and direction of the pipe. Then, the user inputs a cross-sectional area parameter of every pipe at the two end points, for example, in the axial line data for a round pipe, the cross-sectional area parameter is the diameter or radius at the end point.

Step B: deriving the surface shape of multiple joined pipes; in this step, axial line data of every pipe are used for determining connection situation of every pipe. There are “vacant areas” and “overlap areas” situation occurred joined area of pipes. The present invention divides joined area into “direct overlap areas”, “90 degree area” and “filling area” based on the intersecting angle of pipes.

Step C: deriving meshing points which present three-dimensional meshes of multiple joined pipes.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of the present invention.

FIG. 2 is a schematic drawing of multiple three-dimensional pipes.

FIG. 3 is a schematic drawing of building multiple three-dimensional pipes according to the present invention.

FIG. 4 is a geometric shape schematic drawing of the multiple three-dimensional pipes before modification.

FIG. 5 is a schematic drawing of two joined pipes of a first embodiment.

FIG. 6 is a schematic drawing of two joined pipes of a second embodiment.

FIG. 7 is a schematic drawing of two joined pipes of a third embodiment.

FIG. 8 is a schematic drawing of three joined pipes of a first embodiment.

FIG. 9 is a schematic drawing of three joined pipes of a second embodiment.

### DETAILED DESCRIPTION OF THE PREFERRED EMBODIMENT

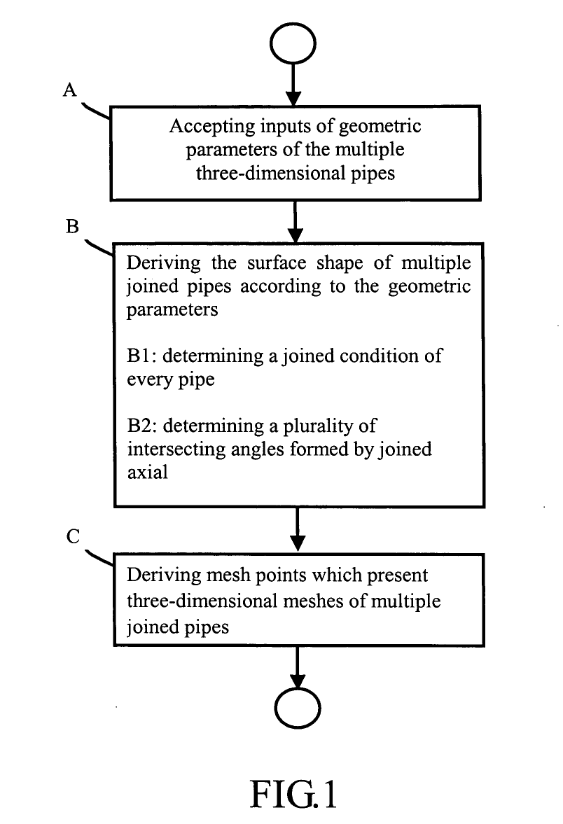

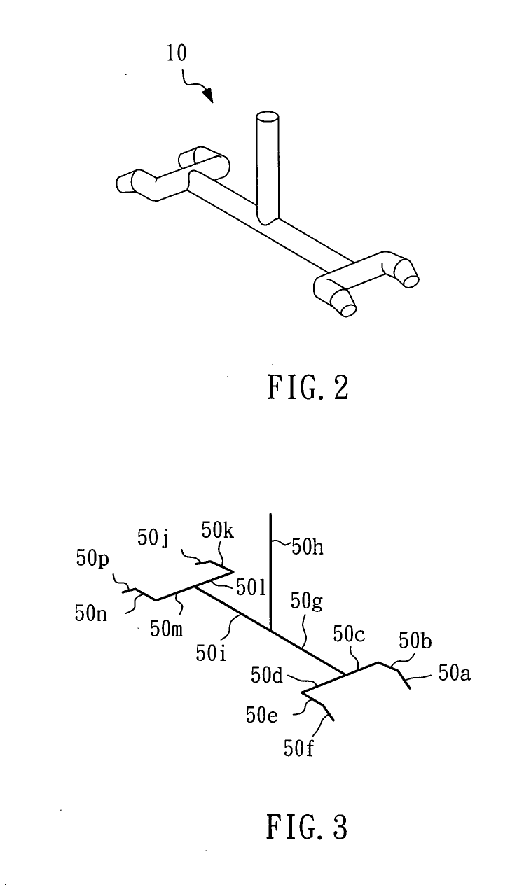

The present invention provides a method for rapidly building multiple three-dimensional pipes for CAD, CAE, CAM or computer graphic design, and also provides a related software program. Please refer to FIG. 1. FIG. 1 is a flowchart of the present invention. FIG. 1 shows the flowchart for a computer aided design software program. Please also refer to FIG. 2 to FIG. 9 in conjunction with FIG. 1.

Step A:

Accepting inputs for the geometric parameters of the multiple three-dimensional pipes.

As shown in FIG. 2, a user may want to build multiple three-dimensional pipes 10 for a mold runner, with the multiple three-dimensional pipes 10 being a plurality of cylindrical pipes.

The user can input geometric parameters (such as coordinate points, circle radii) related to each pipe to define the geometric shape of each pipe. In order to easily provide for multiple three-dimensional pipes, as shown in FIG. 3, the user draws (by, for example, using a mouse) a plurality of axial lines 50a˜50a for the pipes 50a˜50a; these axial lines 50a˜50a provide length and direction data (geometric parameter data). Therefore, two end point data points for the pipe can also be obtained from the axial line.

In the present invention, any two joined pipes must be joined at their end points of their respective axial lines. For example, axial line 50i and axial line 50g are both in the same direction, but axial line 50i and axial line 50g can be considered part of the same axial line; however, since the definition of the present invention requires that a joined point of any two pipes must be at the end point of the one of the axial lines, to support axial line 50h, axial line 50i and axial line 50g are joined together, and this one continuous axial line formed by axial line 50i and axial line 50g must therefore be defined as two axial lines.

Next, the user inputs a cross-sectional area parameter of every pipe at the two end points. For example, in the axial line data for a round pipe, the cross-sectional area parameter is the diameter or radius at the end point. Of course, the user can draw a circle between two end points of every axial line, and a software program can be used to obtain a diameter or radius of the circle.

A cross-sectional area parameter of other non-circular pipes is based upon the shape of the pipe; for example, for a pipe with an ellipsoidal cross-section, the cross-sectional area parameter can be provided by the major and minor axes.

Step B:

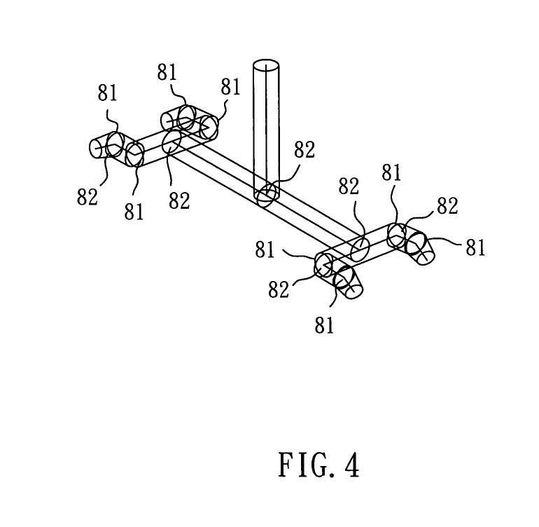

The surface shape of multiple joined pipes is derived according to the geometric parameters. Please refer to FIG. 4. FIG. 4 is a geometric shape schematic drawing of the multiple three-dimensional pipes before modification. There are “vacant areas” 81 and “overlap areas” 82 situations that occur at joined areas of the pipes. Step B is used to fix the vacant areas 81 and the overlap areas 82.

In step B, the surface shape of multiple joined pipes includes non-joined sections and joined sections. The joined sections must undergo processing to account for the vacant areas 81 and the overlap areas 82; therefore step B1 is used for determining the joined condition of every pipe according to the axial line data for each pipe. For example, axial line 50a and axial line 50b are joined, and axial line 50a and axial line 50c are not joined.

In order to fix the vacant areas 81 and the overlap areas 82, step B2 is performed.

Step B2:

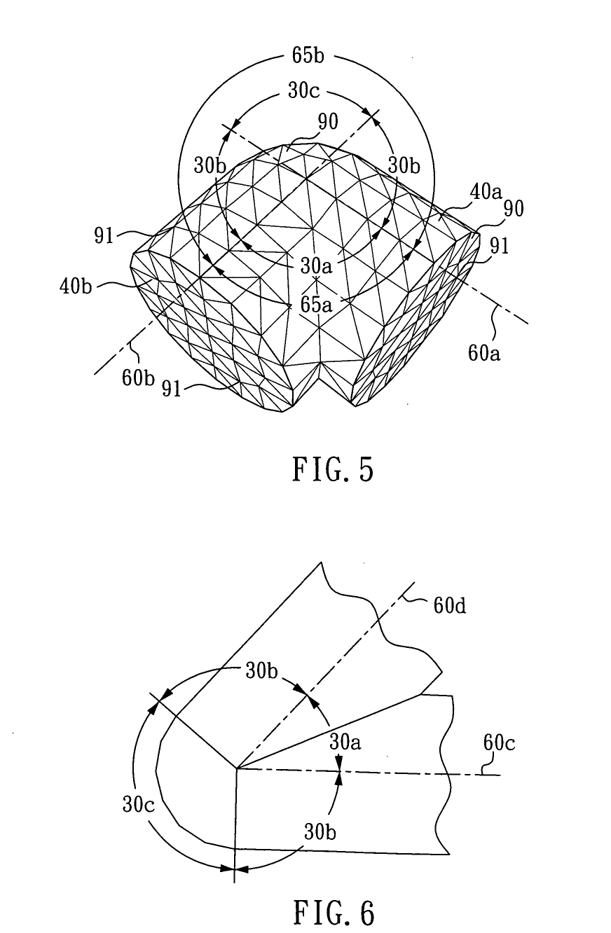

A plurality of intersecting angles formed by joined axial lines are found for every area having joined axial lines. As shown in FIG. 5, two axial lines 60a, 60b are joined and form two intersecting angles 65a, 65b; in other words, every intersecting angle is composed of two axial lines. For example, intersecting angle 65a is composed of axial lines 60a, 60b; intersecting angle 65b is also composed by axial lines 60a, 60b. Of course, the sum total of all intersecting angles (such the sum of intersecting angles 65a, 65b) is 360°. Furthermore, the number of the intersecting angles is equal to the number of joined axial lines; for example, as shown in FIG. 8, three axial lines 60i, 60j, 60k are joined together to form three intersecting angles 65i, 65j, 65k.

There are several conditions for the types of various intersecting angles:

Condition A: when the intersecting angle is less than 180°, the surface shape of two intersected pipes in the angle intersection area is built according to an overlapping area of the surface shape of two intersecting pipes. For example, in FIG. 5, intersecting angle 65a is less than 180° and lies within a defined direct overlapping area 30a. In the direct overlapping area 30a, the surface shape of pipes 40a, 40b is built according to the overlapping area of the surface shape of two intersecting pipes, which means that it is the overlapping area of an intersecting portion.

Condition B: when the intersecting angle equals or exceeds 180°, the intersecting angle area is divided into two areas:

1) Two 90° areas, separately located within a 90° range next to two joined axial lines; the surface shapes of the two pipes in the two 90° areas are the original geometric shapes of the two pipes in the two 90° areas; as shown in FIG. 5, intersecting angle 65b exceeds 180°, therefore, two 90° areas 30b are formed separately located in a 90° range next to axial lines 60a, 60b. The surface shapes of pipes 40a, 40b in the two 90° areas have their original geometric shapes.

2) A filling area, located between two 90° areas; the surface shape of the filling area is an overlapping area of two pipes extending into the filling area, but if the intersecting angle is equal to 180° then there is no filling area; as shown in FIG. 5, filling area 30c is located between two 90° areas 30b; the surface shape of the filling area has a circular shape so that the surface shapes of the two pipes form a continuous, smooth shape at the 90° area and the filling area.

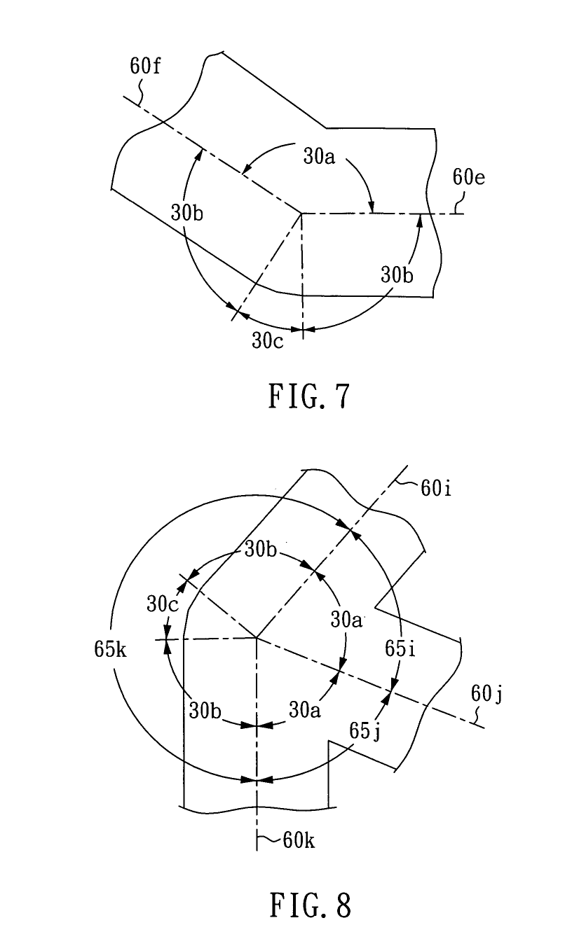

Similarly, FIG. 6 and FIG. 7 are both schematic drawings of two joined pipes. Two axial lines 60c, 60d in FIG. 6 and two axial lines 60e, 60f in FIG. 7 are both joined together and form a direct overlapping area 30a, two 90° areas 30b, and a filling area 30c.

Please refer to FIG. 8. FIG. 8 is a schematic drawing of three joined pipes of a first embodiment. Three axial lines 60i, 60j, 60k are joined together and from three intersecting angles 65i, 65j, 65k. Since intersecting angles 65i, 65j are both less than 180°, two direct overlapping areas 30a are formed. Moreover, because intersecting angle 65k exceeds 180°, two 90° areas 30b, and a filling area 30c are formed.

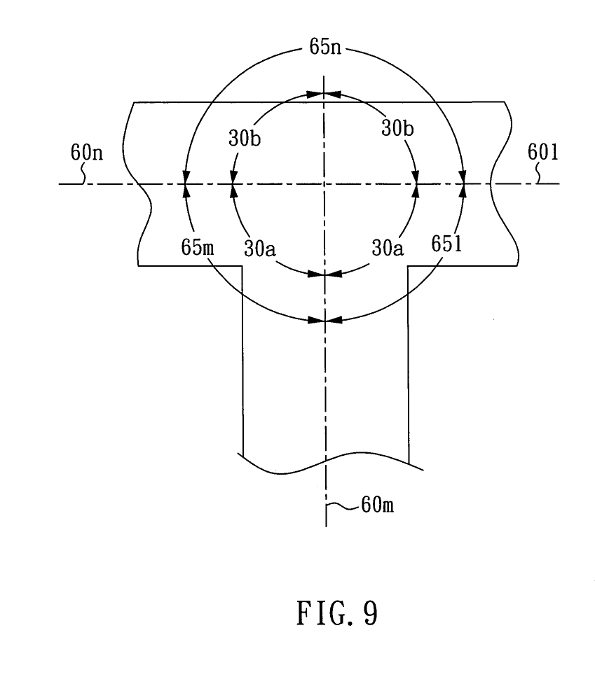

Please refer to FIG. 9. FIG. 9 is a schematic drawing of three joined pipes of a second embodiment. As described in step A, axial line 60l and axial line 60n can be considered a single continuous axial line, but are two axial lines in the definition of the present invention. Similarly, three axial lines 60l, 60m, 60n form three intersecting angles 65l, 65m, 65n. Since both intersecting angles 65l, 65m are less than 180°, two direct overlapping areas 30a are formed. Furthermore, because intersecting angle 65n is equal to 180°, two 90° areas 30b are formed, but there is no filling area 30c.

Step C:

Mesh points arfe derived, which present the three-dimensional meshes of multiple joined pipes. This step is not necessary for the typical computer aided design application as applied to simple mechanical designs, such as AutoCad or ProE. But it may be necessary for Computer Aided Engineering (CAE) as applied to fluid dynamics or analyzers. FIG. 5 shows how to generate mesh points 91 for three-dimensional meshes 90. However, the technology utilizing topology through the operation of geometry to obtain geometric shapes that yield three-dimensional meshes is not the point of the present invention, and so will not be described in any further detail.

Although the present invention has been explained in relation to its preferred embodiment, it is to be understood that many other possible modifications and variations can be made without departing from the spirit and scope of the invention as hereinafter claimed. For example, in the embodiments, the axial lines of the pipes are all straight lines, but they can also be curved so that the pipes are curved as well.

1. A method of rapidly building multiple three-dimensional pipes for CAD, CAM, CAE or computer graphic design application comprising:
step A: accepting inputs of geometric parameters of the multiple three-dimensional pipes, each pipe utilizing an axial line to indicate a length and direction of the pipe, wherein the geometric parameters comprise:
axial line data for each pipe, which includes two end point data points for the axial line; and
a cross-sectional area parameter of every pipe at the two end points; and
step B: deriving the surface shape of multiple joined pipes according to the geometric parameters; wherein the surface shape of the multiple joined pipes includes non-joined sections and joined sections, and the method further comprises the following step for the joined sections:
step B1: determining a joined condition of every pipe according to the axial line data for every pipe; and
step B2: determining a plurality of intersecting angles formed by joined axial lines for every area having the joined axial lines, wherein every intersecting angle is composed of two axial lines of two pipes, the number of intersecting angles is equal to the number of the joined axial lines, and a sum total angle of the plurality of intersecting angles is 360°; wherein there are three different conditions according to different intersecting angles, which include:
a condition when the intersecting angle is less than 180°: the surface shape of two intersecting pipes in the intersecting angle area is built according to an overlapping area of the surface shape of two intersecting pipes; and
a condition when the intersecting angle exceeds 180°: the intersecting angle area is divided into two areas:
two 90° areas, separately located in a 90° range next to two joined axial lines, the surface shapes of the two pipes in the two 90° areas being the original geometric shape of the two pipes in the two 90° areas; and
a filling area, located between the two 90° areas, the surface shape of the filling area being an overlapping area of two pipes extending into the filling area, but if the intersecting angle is 180°, then there is no filling area.

2. The method of rapidly building multiple three-dimensional pipes as claimed in claim 1, wherein the pipe is a cylindrical pipe, and the cross-sectional area parameter of the cylindrical pipe is a diameter or radius of the cylindrical pipe.

3. The method of rapidly building multiple three-dimensional pipes as claimed in claim 1, wherein the axial line data of the pipe is input by a user drawing lines.

4. The method of rapidly building multiple three-dimensional pipes as claimed in claim 1, wherein any two joined pipes must be joined at their respective axial line end points.

5. The method of rapidly building multiple three-dimensional pipes as claimed in claim 2, wherein the surface shape of the filling area has a circular shape so that the surface shapes of the two pipes form a continuous smooth shape at the 90° area and the filling area.

6. The method of rapidly building multiple three-dimensional pipes as claimed in claim 2 being used for a runner design of a mold.

7. The method of rapidly building multiple three-dimensional pipes as claimed in claim 6, wherein the axial line data of the pipe is input by a user drawing lines.

8. The method of rapidly building multiple three-dimensional pipes as claimed in claim 1 further comprising a step C: deriving mesh points which present three-dimensional meshes of multiple joined pipes.

9. A computer readable object for a computer aided design application, the object comprising a medium for recording program code, the medium comprising the follow program code:
a first program code for accepting inputs of geometric parameters of multiple three-dimensional pipes, each pipe utilizing an axial line to indicate a length and direction of the pipe, wherein the geometric parameters comprise:
axial line data for each pipe, which includes two end point data points for each axial line;
a cross-sectional area parameter of every pipe at the two end points;
a second program code for deriving the surface shape of multiple joined pipes according to the geometric parameters; wherein the surface shape of the multiple joined pipes includes non-joined sections and joined sections, and the method further comprises the following steps for the joined sections:
a third program code for determining a joined condition of every pipe according to the axial line data of every pipe; and
a fourth program code for determining a plurality of intersecting angles formed by joined axial lines for every area having the joined axial lines, wherein every intersecting angle is composed of two axial lines of two pipes, the number of intersecting angles being equal to the number of joined axial lines, and a sum total angle of the plurality of intersecting angles being 360°; wherein there are three different conditions according to different intersecting angles:
a condition when the intersecting angle is less than 180°: the surface shape of two intersected pipes in the intersecting angle area is determined according to an overlapped area of the surface shape of two intersected pipes; and
a condition when the intersecting angle exceeds 180°: the intersecting angle area is divided into two areas:
two 90° areas, separately located in a 90° range next to two joined axial lines, the surface shapes of the two 90° areas being the original geometric shape of the two pipes in the two 90° areas; and
a filling area, locating between the two 90° areas, the surface shape of the filling area being an overlapped area of two pipes extending into the filling area, but if the intersecting angle is 180°, then there is no filling area.

10. The computer readable object as claimed in claim 9, wherein the pipe is a cylindrical pipe, and the cross-sectional area parameter of the cylindrical pipe is a diameter or radius of the cylindrical pipe.

11. The computer readable object as claimed in claim 9, wherein the axial line data of the pipe is input by a user drawing lines.

12. The computer readable object as claimed in claim 9, wherein any two joined pipes must be joined at their respective axial line end points.

13. The computer readable object as claimed in claim 10, wherein the surface shape of the filling area has a circular shape so that the surface shapes of the two pipes form a continuous smooth shape at the 90° area and the filling area.

14. The computer readable object as claimed in claim 10 being used for a runner design of a mold.

15. The computer readable object as claimed in claim 14, wherein the axial line data of the pipe is input by a user drawing lines.

16. The computer readable object as claimed in claim 9 further comprising a fifth program code for deriving mesh points which present three-dimensional meshes of the multiple joined pipes.
